(19) United States
(12) Patent Application Publication
(10) Pub. No.: US 2026/0139527 A1
(43) Pub. Date: May 21, 2026

(54) FLUSH DOOR HANDLE

(71) Applicant: TOYOTA JIDOSHA KABUSHIKI KAISHA, Toyota-shi (JP)

(72) Inventors: Tetsuya NAGASAKI, Okazaki-shi (JP); Kazuki Takenaka, Nagoya-shi (JP); Jun Aoki, Nagoya-shi (JP)

(21) Appl. No.: 19/329,946

(22) Filed: Sep. 16, 2025

(30) Foreign Application Priority Data
Nov. 20, 2024 (JP) 2024-202606

(51) Int. Cl. E05B 85/10

(52) U.S. Cl. CPC E05B 85/103

(57) ABSTRACT

The flush door handle includes an inner panel unit that defines a workspace that accepts fingers inside the side door, and an outer panel unit that defines a handle opening that communicates with the workspace on an outer surface of the side door. In the flush door handle, the inner panel unit and the outer panel unit both have a fracture origin at which strength is decreased from a periphery near a front end of the workspace.

### CROSS-REFERENCE TO RELATED APPLICATION

This application claims priority to Japanese Patent Application No. 2024-202606 filed on Nov. 20, 2024. The disclosure of the above-identified application, including the specification, drawings, and claims, is incorporated by reference herein in its entirety.

### BACKGROUND

### 1. Technical Field

The present specification discloses a flush door handle provided in a side door of a vehicle.

### 2. Description of Related Art

As is well known, on an outer surface of a side door of a vehicle, a door handle that is operated when the side door is opened and closed is disposed. In the related art, many door handles are grip-type door handles. The grip-type door handle has a grip portion that is gripped by a user. In a case of the grip-type door handle, the grip portion often protrudes outward from the outer surface of the side door. In this case, a design quality of the vehicle is impaired or aerodynamic resistance is increased.

Therefore, in recent years, a flush door handle has been proposed with the purpose of improving the design quality, reducing the aerodynamic resistance, or both. For the flush door handle, a recess is provided in a side door. An occupant inserts his/her fingers into the recess and operates the flush door handle. In such a flush door handle, almost all components thereof are housed inside the side door. Therefore, as to the flush door handle, the components are less likely to protrude outward from an outer surface of the side door. As a result, the design quality is improved, and the aerodynamic resistance is reduced.

Here, since the door handle is disposed on the side door, when a side impact occurs, the door handle is deformed or displaced by receiving a side impact load. Techniques for solving such problems caused by the deformation or displacement of the door handle have been proposed in the related art. For example, Japanese Unexamined Patent Application Publication No. 2020-66318 (JP 2020-66318 A) discloses a grip-type door handle that can restrain accidental opening of a side door at the time of a side impact. In JP 2020-66318 A, a certain gap is provided between the door handle and an outer surface of the side door, so that swinging of the door handle is restricted at the time of a side impact, thereby restraining opening of the side door.

### SUMMARY

However, in JP 2020-66318 A, movement of the door handle toward a vehicle cabin at the time of a side impact is not sufficiently considered. That is, at the time of a side impact, a part of the door handle may be largely moved toward the vehicle cabin. In particular, the flush door handle is large and close to the vehicle cabin because the components of the door handle are embedded in the side door. Therefore, at the time of a side impact, there is a possibility that the flush door handle deeply intrudes into the vehicle cabin. In the related art including JP 2020-66318 A, the intrusion of the flush door handle into the vehicle cabin has not been studied.

Therefore, the present specification discloses a flush door handle that can restrain the flush door handle from intruding toward a vehicle cabin at the time of a side impact.

A flush door handle includes
an inner panel unit that defines a workspace for receiving a finger, inside a side door, and an outer panel unit that defines a handle opening that communicates with the workspace, on an outer surface of the side door.
   In the flush door handle, each of the inner panel unit and the outer panel unit includes a fracture origin having strength lower than surrounding portions, near a front end of the workspace.

In this case, the inner panel unit may include
a handle case, and
a switch cover that covers at least a part of the handle case from an inner side in a vehicle width direction,
the handle case may include a groove recessed toward an outer side in the vehicle width direction and extending in a vehicle up-down direction, in a position forward of the workspace, and
the groove may function as the fracture origin.

In addition, the outer panel unit may include
a garnish fixed to the outer surface of the side door, and
an extension disposed on a back side of the garnish,
the extension may include a front flange portion positioned forward of the handle opening in a vehicle front-rear direction,
the front flange portion may include a plurality of protrusions protruding toward the handle case, and a plurality of thin plate portions without the protrusions, and
among the thin plate portions, a first thin plate portion adjacent to the handle opening may function as the fracture origin.

Further, the switch cover may include a bending portion that bends to protrude toward the outer side in the vehicle width direction, in the position forward of the workspace, the bending portion may function as the fracture origin, and
the groove, the bending portion, and the first thin plate portion may be aligned in a straight line.

In addition, the flush door handle may be disposed to be inclined with respect to a vehicle front-rear direction such that a front end of the flush door handle is positioned on an inner side in a vehicle width direction with respect to a rear end of the flush door handle.

According to a technique disclosed in the present specification, a fracture of the flush door handle is likely to occur at the time of a side impact. As a result, intrusion of the flush door handle into the vehicle cabin can be effectively restrained.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is a side view of a vehicle;

FIG. 1B is an enlarged view of a part of FIG. 1A;

FIG. 2 is an exploded perspective view of main components of a flush door handle;

FIG. 3 is a schematic view of a flush door handle as seen from a vehicle cabin side;

FIG. 4 is a IV-IV cross-sectional view of FIG. 1B;

FIG. 5 is a V-V sectional view of FIG. 1B;

FIG. 6A is a diagram showing an appearance of the flush door handle at the time of the side impact; and

FIG. 6B is a diagram showing an appearance of the flush door handle at the time of the side impact.

### DETAILED DESCRIPTION OF EMBODIMENTS

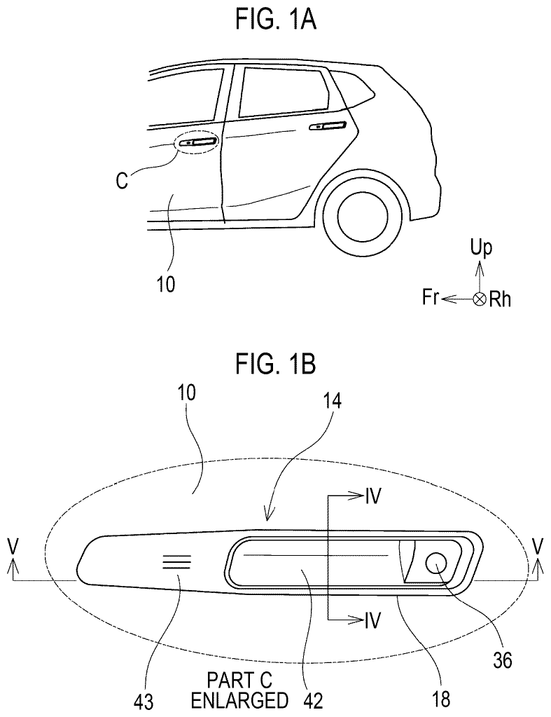

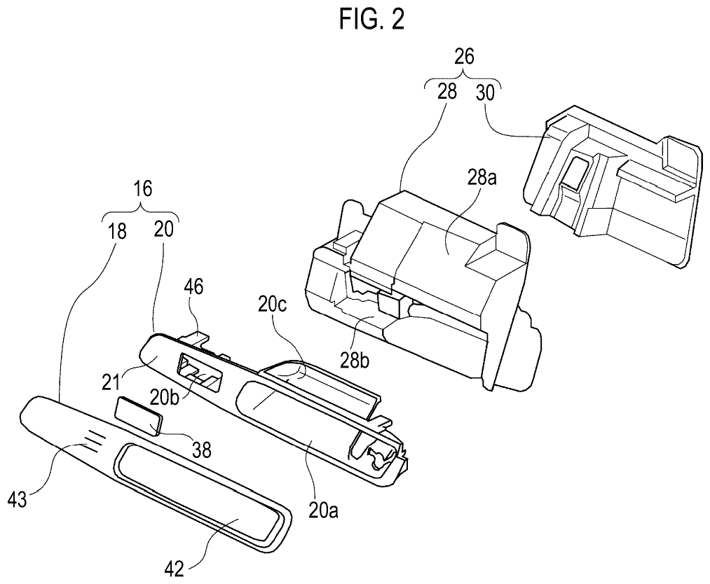

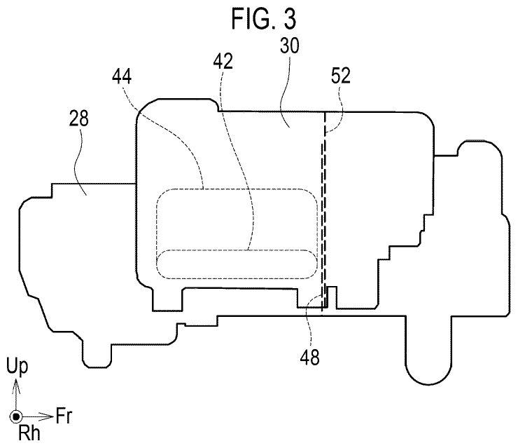

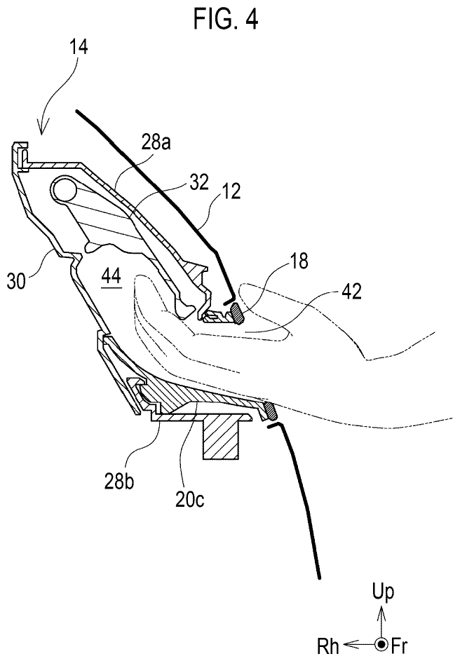

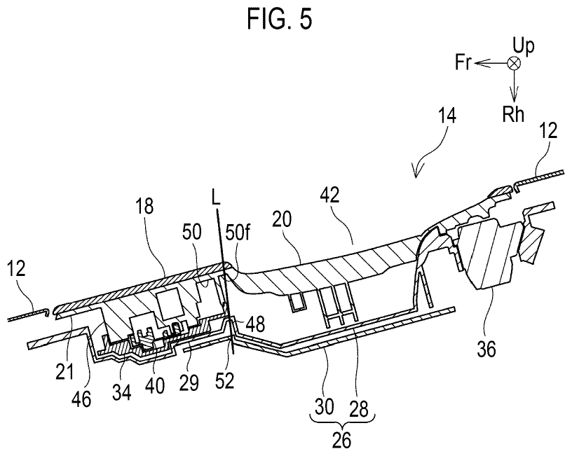

Hereinafter, the configuration of the flush door handle 14 will be described with reference to the drawings. FIG. 1A is a side view of a vehicle. Further, FIG. 2 is an exploded perspective view of main components of the flush door handle 14, and FIG. 3 is a schematic view of the flush door handle 14 as viewed from the vehicle cabin side. Further, FIG. 4 is a cross-sectional view taken along line IV-IV of FIG. 1B, and FIG. 5 is a sectional view taken along line V-V of FIG. 1B.

The flush door handle 14 is a door handle attached to the side door 10. The user operates the flush door handle 14 when the user opens the side door 10 from the outer side of the vehicle. As shown in FIG. 4, many components of the flush door handle 14 are housed inside the side door 10, and there is no component that protrudes outward from the outer panel 12 of the side door 10. With such a configuration, the flush door handle 14 is less noticeable, and the design quality of the side door 10 is further improved. In addition, since there is no component that protrudes from the outer panel 12, the air resistance of the vehicle is reduced.

As shown in FIG. 4, in the case of the flush door handle 14, a handle opening 42 is provided on an outer surface of the side door 10, and a recess that is connected to the handle opening 42, that is, a workspace 44 is provided in the side door 10. Inside the workspace 44, a handle lever 32 for operating a latch (not shown) of the side door 10 is disposed. When the user opens the side door 10, the user inserts a hand from the handle opening 42 into the workspace 44 and pulls the handle lever 32 toward the user (that is, toward the user's body). As a result, the handle lever 32 is rotated, and the latch of the side door 10 is released. Then, in this state, the side door 10 with the latch released is opened by further pulling the hand toward the front side.

As shown in FIGS. 2, 4, and 5, the flush door handle 14 includes an outer panel unit 16, an inner panel unit 26, and a handle lever 32 (see FIG. 4). The outer panel unit 16 is fixed to the outer panel 12 and defines a handle opening 42. The outer panel unit 16 is roughly divided into a garnish 18 and an extension 20.

The garnish 18 is a decorative panel disposed on an outer surface of the side door 10. An outer surface of the garnish 18 is smoothly connected to an outer surface of the outer panel 12. As shown in FIG. 2, the garnish 18 is an elongated plate shape in a vehicle front-rear direction. The garnish 18 is provided with a handle opening 42 that is elongated in the front-rear direction and is disposed to be biased to the rear side of the vehicle. The portion of the vehicle in front of the handle opening 42 functions as a touch portion 43. The flush door handle 14 further has a switch sensor 38 (see FIG. 2) that detects contact of fingers with the touch portion 43. Then, the side door 10 is unlocked or locked by the switch sensor 38 detecting the contact of the fingers. The touch portion 43 of the garnish 18 is provided with a pattern (in the example of FIG. 2, three vertical lines) indicating the contact position of the fingers.

The extension 20 is disposed on the back side of the garnish 18. The extension 20 is a resin part interposed between the garnish 18 and the handle case 28. The extension 20 has the handle opening 20a in a disposition biased to the vehicle rear side, similarly to the garnish 18. Further, a guide portion 20c extending toward the inner side in the vehicle width direction is provided in the vicinity of the lower edge of the handle opening 20a (see FIGS. 2 and 4). The guide portion 20c has a curved shape extending obliquely upward from the lower edge of the handle opening 20a. As shown in FIG. 4, the user causes the hand to enter the workspace 44 along the guide portion 20c.

In addition, in the extension 20, the front portion of the handle opening 20a, that is, the portion overlapping the touch portion 43 of the garnish 18 in the vehicle width direction functions as the front flange portion 21. A substantially rectangular sensor opening 20b is provided in the front flange portion 21. The switch sensor 38 is attached to the sensor opening 20b. The switch sensor 38 detects that the fingers contact the touch portion 43.

Further, a rib 46 that is a plurality of protrusions protruding toward the handle case 28 (that is, toward the inner side in the vehicle width direction) is provided around the sensor opening 20b. As shown in FIG. 5, the antenna 40 is held in a space between the rib 46 and the handle case 28. The antenna 40 performs short-distance wireless communication with a smart key of the vehicle. Then, the presence or absence of the user around the side door 10 is determined based on the communication result of the antenna 40.

As is clear from FIG. 5, the front flange portion 21 is divided into a portion in which the ribs 46 protrude and a thin plate portion 50 in which the ribs 46 are not present. Hereinafter, among the thin plate portions 50, the thin plate portion 50 adjacent to the handle opening 42 is referred to as a “first thin plate portion 50f”.

The inner panel unit 26 is roughly divided into a handle case 28 and a switch cover 30. As shown in FIG. 4, the handle case 28 and the switch cover 30 define a workspace 44 inside the side door 10. More specifically, as shown in FIG. 4, the handle case 28 has a wall 28a that extends from an upper edge of the handle opening 20a toward the inner side and upper side in the vehicle width direction, and a wall 28b that extends from a lower edge of the handle opening 42 toward the inner side in the vehicle width direction. The two walls 28a, 28b function as the bottom wall, the top wall, and the wall on the outer side in the vehicle width direction of the workspace 44. The switch cover 30 covers a part of the handle case 28 from the inner side in the vehicle width direction. As a result, a part of the switch cover 30 functions as an inner wall of the workspace 44 in the vehicle width direction. As described above, the handle lever 32 is disposed inside the workspace 44. The handle lever 32 is operated to release the latch of the side door 10.

As shown in FIG. 5, the handle case 28 also extends to the rear side and the front side of the workspace 44. The key cylinder 36 is attached to a rear portion of the handle case 28 from the workspace 44. When the keyless entry function cannot be used for some reason, the user unlocks the side door 10 by rotating the key cylinder 36 with a physical key.

A portion of the handle case 28 in front of the workspace 44 functions as a front flange portion 29 facing the front flange portion 21 of the extension 20. The antenna 40 is held in a space between the front flange portion 29 and the rib 46. In addition, more strictly, the antenna case 34 is disposed between the front flange portion 29 and the antenna 40, and the antenna 40 is held by the antenna case 34.

Here, as shown in FIG. 5, a boundary groove 48 that is recessed outward in a vehicle width direction is provided in a boundary portion between the front flange portion 29 and the workspace 44. FIG. 3 shows an approximate shape of the boundary groove 48 by a broken line. As shown in FIG. 3, the boundary groove 48 extends in the vehicle up-down direction. The reason for providing the boundary groove 48 will be described later.

The switch cover 30 is a resin part that covers at least a part of the handle case 28 from the inner side in the vehicle width direction. As shown in FIGS. 3 and 5, in the switch cover 30, the bending portion 52 that is bent to protrude outward in the vehicle width direction is provided at a portion facing the boundary groove 48 in the vehicle width direction.

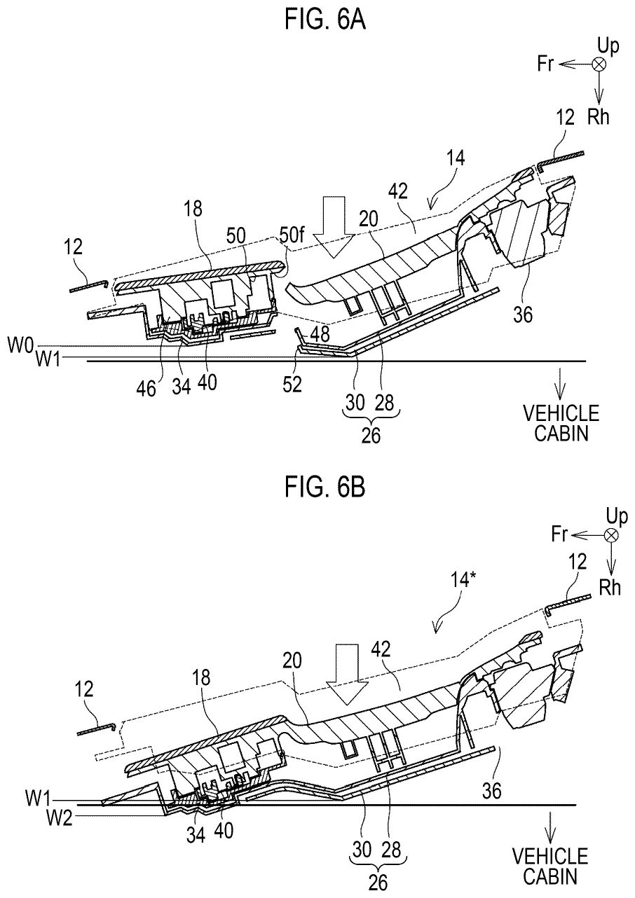

Here, the bending portion 52 is a fracture origin at which stress is concentrated and a fracture is likely to occur. Similarly, the boundary groove 48 provided in the handle case 28 and the first thin plate portion 50f provided in the extension 20 also become the fracture origin where the stress is concentrated and the fracture is likely to occur. In the present example, the three fracture origins 48, 50f, 52 are disposed to be substantially aligned in a straight line. The antenna case 34 is set to a position and a shape that do not interfere with a straight line L passing through the three fracture origins 48, 50f, 52. The reason for such a configuration will be described with reference to FIGS. 6A and 6B.

FIGS. 6A and 6B are diagrams showing the appearance of the flush door handles 14, 14* when a side impact in which an obstacle collides with a side of the vehicle occurs. FIG. 6A shows the flush door handle 14 of the example, and FIG. 6B shows the flush door handle 14* of the comparative example. In FIGS. 6A and 6B, one-dot chain lines indicate the approximate positions and shapes of the flush door handles 14, 14* before the side impact occurs.

As described above, the flush door handles 14, 14* are attached to the side door 10 of the vehicle. In addition, as shown in FIGS. 6A and 6B, the outer panel 12 of the side door 10 is inclined with respect to the vehicle front-rear direction such that the outer panel 12 progresses toward the outer side in the vehicle width direction as the outer panel 12 extends toward the rear of the vehicle. As a result, the flush door handles 14, 14* themselves are also inclined with respect to the vehicle front-rear direction.

In this state, a case where the side impact occurs will be considered. In the case of the flush door handle 14* of the comparative example, there is no fracture origin. In this case, when the flush door handle 14* receives the side impact load, the stress is less likely to be concentrated, and the flush door handle 14* is less likely to be fractured. As a result, an entirety of the flush door handle 14* moves to the inner side in the vehicle width direction. In the case of the example shown in FIG. 6B, the vehicle width direction position of the intermediate portion Pc of the flush door handle 14* is the position W1 away from the vehicle cabin, and the vehicle width direction position of the front portion Pf of the flush door handle 14* is the position W2 that intrudes the vehicle cabin. That is, in a case where the fracture of the flush door handle 14* does not occur, the flush door handle 14*, particularly a vicinity of a front end of the flush door handle 14* is likely to intrude into the vehicle cabin. In a case of the flush door handle in which a large number of the components are disposed inside the side door 10, the problem that a part of the components of the handle enters the vehicle cabin is likely to occur.

On the other hand, in the case of the flush door handle 14 of the present example, the fracture origins 50f, 48, 52 are present in each of the extension 20, the handle case 28, and the switch cover 30, and the three fracture origins 50f, 48, 52 are aligned on a straight line. In this case, when the side impact load is applied, the fracture is likely to occur at the fracture origins 50f, 48, 52. In addition, the occurrence of the fracture causes the front portion and the rear portion of the flush door handle 14 to move independently from each other. Specifically, as shown in FIG. 6A, even in a case where the intermediate portion Pc of the flush door handle 14 moves to the position W1 due to the side impact load, the front portion Pf of the flush door handle 14 can move independently from the intermediate portion Pc. As a result, the front portion Pf can stay at the position W0 away from the vehicle cabin. As a result, the amount of intrusion of the flush door handle 14 into the vehicle cabin at the time of the side impact can be reduced to zero or the amount of intrusion can be reduced.

As is clear from the above description, according to the technique disclosed in the present specification, the flush door handle 14 is easily fractured at the time of the side impact. As a result, the intrusion of the flush door handle 14 into the vehicle cabin can be effectively suppressed. The configurations described above are examples, and other configurations may be changed as long as both the inner panel unit 26 and the outer panel unit 16 have a fracture origin having a lower strength than the periphery in the vicinity of the front end of the workspace 44. For example, the configuration of the fracture origin may be appropriately changed. For example, the fracture origin of the handle case 28 may be a thin plate portion in which the plate thickness is locally smaller than the surrounding portion, rather than the boundary groove 48. In addition, the shapes of the garnish 18, the extension 20, the handle case 28, and the switch cover 30 may be appropriately changed.

What is claimed is:

1. A flush door handle comprising:
an inner panel unit that defines a workspace for receiving a finger, inside a side door; and
an outer panel unit that defines a handle opening that communicates with the workspace, on an outer surface of the side door, wherein each of the inner panel unit and the outer panel unit includes a fracture origin having strength lower than surrounding portions, near a front end of the workspace.

2. The flush door handle according to claim 1, wherein:
the inner panel unit includes
a handle case, and
a switch cover that covers at least a part of the handle case from an inner side in a vehicle width direction;
the handle case includes a groove recessed toward an outer side in the vehicle width direction and extending in a vehicle up-down direction, in a position forward of the workspace; and
the groove functions as the fracture origin.

3. The flush door handle according to claim 2, wherein:
the outer panel unit includes
a garnish fixed to the outer surface of the side door, and
an extension disposed on a back side of the garnish;
the extension includes a front flange portion positioned forward of the handle opening in a vehicle front-rear direction;
the front flange portion includes a plurality of protrusions protruding toward the handle case, and a plurality of thin plate portions without the protrusions; and
among the thin plate portions, a first thin plate portion adjacent to the handle opening functions as the fracture origin.

4. The flush door handle according to claim 3, wherein:
the switch cover includes a bending portion that bends to protrude toward the outer side in the vehicle width direction, in the position forward of the workspace;
the bending portion functions as the fracture origin; and
the groove, the bending portion, and the first thin plate portion are aligned in a straight line.

5. The flush door handle according to claim 1, wherein the flush door handle is disposed to be inclined with respect to a vehicle front-rear direction such that a front end of the flush door handle is positioned on an inner side in a vehicle width direction with respect to a rear end of the flush door handle.
